(19) United States
(12) Patent Application Publication
(10) Pub. No.: US 2008/0129541 A1
(43) Pub. Date: Jun. 5, 2008

(54) BLACK ICE DETECTION AND WARNING SYSTEM

(75) Inventors: Yuesheng Lu, Farmington Hills, MI (US); Michael J. Higgins-Luthman, Livonia, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: MAGNA ELECTRONICS, Holly, MI (US)

(21) Appl. No.: 11/948,086

(22) Filed: Nov. 30, 2007

Related U.S. Application Data
(60) Provisional application No. 60/872,270, filed on Dec. 1, 2006.

(51) Int. Cl. G08G 1/09; G06K 9/00

(52) U.S. Cl. 340/905; 382/108

(57) ABSTRACT

A black ice detection system for a vehicle includes an imaging sensor disposed at the vehicle and having a forward field of view in a direction of forward travel of the vehicle and a control operable to process images captured by the imaging sensor and operable to detect and discern black ice on a surface in front of the vehicle in response to the image processing.

### CROSS REFERENCE TO RELATED APPLICATION

The present application claims benefit of U.S. provisional application Ser. No. 60/872,270, filed Dec. 1, 2006, which is hereby incorporated herein by reference in its entirety.

### FIELD OF THE INVENTION

The present invention relates to vision systems for vehicles and, more particularly, to a forward facing vision or imaging system of a vehicle.

### BACKGROUND OF THE INVENTION

Black ice, also known as “glare ice” or “clear ice”, typically refers to a thin coating of glazed ice on a surface, often a roadway. While not truly black, it is substantially transparent, allowing the usually-black asphalt roadway to be seen through it such that the ice is hardly discernible to a person viewing the roadway. Such black ice also is unusually slick compared to other forms of ice on roadways. In addition, it often has a matte appearance rather than the expected gloss; and often is interleaved with wet pavement, which is identical in appearance. For this reason it is especially hazardous when driving because it is both hard to see and extremely slick. Regular forward facing vision systems have the same difficulties as human eyes do to detect black ice. In the U.S., hundreds of fatal crashes with over a thousand deaths are reported by NHTSA every year. The table of FIG. 1 shows a statistics of fatal crashes related with icy roadways in the past 5 years in the U.S. from Fatality Analysis Report System of NHTSA. NTHSA's reports do not include the numbers for non-fatal crashes which are expected to be many times more than fatal crashes.

The table of FIG. 1 lists data from the U.S. only. There should be a sizeable commercial market world-wide for a safety system in passenger and commercial vehicles that is capable of detecting and warning black ice on roadway. In a report by European Photonics Industry Consortium and Yole Development, black ice detection was listed along with lane departure warning (LDW), adaptive cruise control, blind spot detection and rear view or rear vision systems, and the like, as safety functions currently in development.

### SUMMARY OF THE INVENTION

The present invention provides a black ice detection and warning system for a vehicle that detects black ice on the road in front of the vehicle and provides an alert or indication of the detected black ice so that the driver may adapt his or her driving accordingly. The information or indication of the existence of black ice and the distance and size of the black ice may also or otherwise be directly fed or communicated to a control or control system of the vehicle so that the vehicle control system or systems (such as, for example, the anti-lock braking system or traction control system of the vehicle) can take reactive action in response to a detection of an icy area at the road surface in front of the vehicle and/or in the path of travel of the vehicle. The black ice detection and warning system of the present invention may utilize a forward facing image sensor that captures images of the road surface in front of the vehicle, whereby the images are processed to determine if black ice if present in the vehicle path of travel.

As used herein, the term “black ice” is intended to encompass black or clear or glare ice or other similar, substantially smooth and thus difficult to discern types of ice formations or icy patches that may form or be disposed or otherwise occur at or on a road surface, and is not intended to be limited to a single specific type of ice. Further, although the black ice detection and warning system of the present invention is operable to detect such black ice, the system may also detect other types of ice formations or icy/snowy patches, such as rough ice or snow or slush or water or the like, that may be present at the road surface.

According to an aspect of the present invention, a black ice detection system for a vehicle includes an imaging sensor disposed at the vehicle and having a forward field of view in a direction of forward travel of the vehicle, and a control. The control is operable to process images captured by the imaging sensor and is operable to detect and discern black ice on a surface in front of the vehicle in response to the image processing.

Optionally, the black ice detection system may include a polarizing element that polarizes light such that light waves in one or more particular orientations are received by the imaging sensor and light waves in other orientations are substantially attenuated. Optionally, the black ice detection system may include an illumination source that is selectively actuatable to illuminate an area in front of the vehicle. Optionally, and desirably, the black ice detection system may provide an alert or warning signal to the driver of the vehicle to alert the driver that black ice has been detected ahead of the vehicle. Optionally, the black ice detection system may provide information, such as the existence of the black ice, the distance of the black ice in front of the vehicle and the length of the black ice in the vehicle's driving direction, to one or more vehicle controls or control systems through a vehicle communication bus or other means, so that the vehicle can take reactive actions in response to the detection and/or indication of black ice in the path of travel of the vehicle. Optionally, the black ice detection system may detect and discern other ice and snow and water formations or patches that are detected on the road surface ahead of the vehicle or otherwise in the path of the vehicle.

These and other objects, advantages, purposes and features of the present invention will become apparent upon review of the following specification in conjunction with the drawings.

### BRIEF DESCRIPTION OF THE DRAWINGS

FIG. 1 is a Table showing the statistics of fatal crashes related with icy roadways (source: Fatality Analysis Report System of NHTSA);

FIG. 2 is a schematic of how light reflects from an ice surface, and shows that, after being reflected from the ice surface, the light changes its polarization composition, and the parallel polarization is reflected less than perpendicular polarization;

FIG. 3 is a schematic of how light reflects backward from an ice surface, and shows that backward reflected light carries polarization changes caused by the ice surface;

FIG. 4 is a perspective view of the field of view forward of the vehicle, showing an identification of a black ice area on the road surface ahead of the vehicle from a processed camera view;

FIGS. 5A-5D are block diagrams of black ice detection and warning systems in accordance with the present invention;

FIG. 6 is a side elevation of a vehicle incorporated with the black ice detection and warning system of the present invention, as operating in a passive mode;

FIG. 7 is a side elevation of a vehicle incorporated with the black ice detection and warning system of the present invention, as operating in an active mode utilizing a near infrared illumination source; and

FIG. 8 is a side elevation of a vehicle incorporated with the black ice detection and warning system of the present invention, as operating in an active mode utilizing the headlamps of the vehicle as the illumination source.

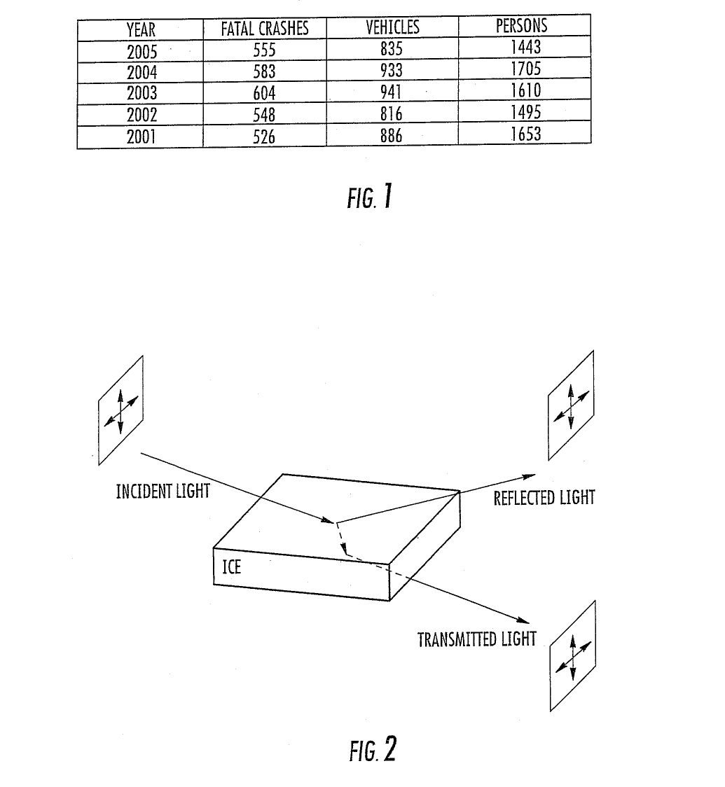

### DESCRIPTION OF THE PREFERRED EMBODIMENTS

Referring now to the drawings and the illustrative embodiments depicted therein, a black ice detection and warning system 10 is operable to detect the presence of black ice on a road surface in front of a vehicle. The black ice detection and warning system 10 may provide an alert or warning signal to the driver of the vehicle to warn the driver that the vehicle is approaching the detected black ice, which may pose a potentially hazardous driving condition. Preferably, the warning signal is provided while the black ice is far enough away from the vehicle that the driver has sufficient time to react and possibly change or adjust the manner in which the driver is driving the vehicle so as to safely avoid or maneuver through or around the detected black ice, as discussed below.

The desired distance of detecting an icy surface in front of a vehicle is estimated to be a sufficient distance so as to provide more than 2 seconds of advanced warning to the driver. That translates to about 50 meters for a vehicle that is traveling at about 55 mph. That will provide enough time for the driver to start to be alert, slow down or even stop before reaching the ice. Thus, the black ice detection and warning system of the present invention preferably views and detects the road surface condition at least 50 meters ahead of the subject vehicle. More preferably, the black ice detection and warning system may detect road surface conditions at about 100 meters ahead of the vehicle.

Optionally, the black ice detection and warning system 10 may provide black ice detection information to the vehicle or vehicle control or control system through vehicle communication bus or other means. Examples of vehicle communication buses include buses such as CAN and J1850 and/or the like. The black ice detection and warning system 10 may, for example, provide the following information to vehicle: the existence of black ice, the distance of the black ice, the width and length of the black ice, and the ice type (such as ice/water mixture or snow/ice mixture or the like), and/or other suitable or useful information pertaining to the detected ice or icy area. The vehicle control system or systems, which may include an anti-lock brake system, a traction control system or stability control system or the like, receive and process the information and may control the vehicle in response to the provided information to react to the detected black ice condition. In such a non-driver alert configuration, a shorter detection distance may be desired or necessary.

In order to detect “black ice” on the road in front of the vehicle, a spectroscopic polarization optical imaging system may be used, and may detect the presence of black ice on the roadway (such as at a distance of about 50 meters or more or less, depending on the particular application) ahead of the vehicle, whereby a warning or alert signal may be provided to warn the driver of the vehicle or a control system of the vehicle of the presence of black ice in the vehicle's path. The principle of the black ice detection and warning (BIDW) system of the present invention is that the system is operable to detect black ice based on Fresnel's equation in optics, which describes the reflection and transmission of the light at the interface of two mediums with different indices of reflection, whereby the light waves oriented parallel to and perpendicular to the incident plane are reflected and transmitted at a different ratio. By applying polarization optics in the camera or detector, which discreetly measures the level of light at parallel and/or perpendicular polarization orientations, the black ice detection warning system of the present invention can identify the existence of black ice on the road surface.

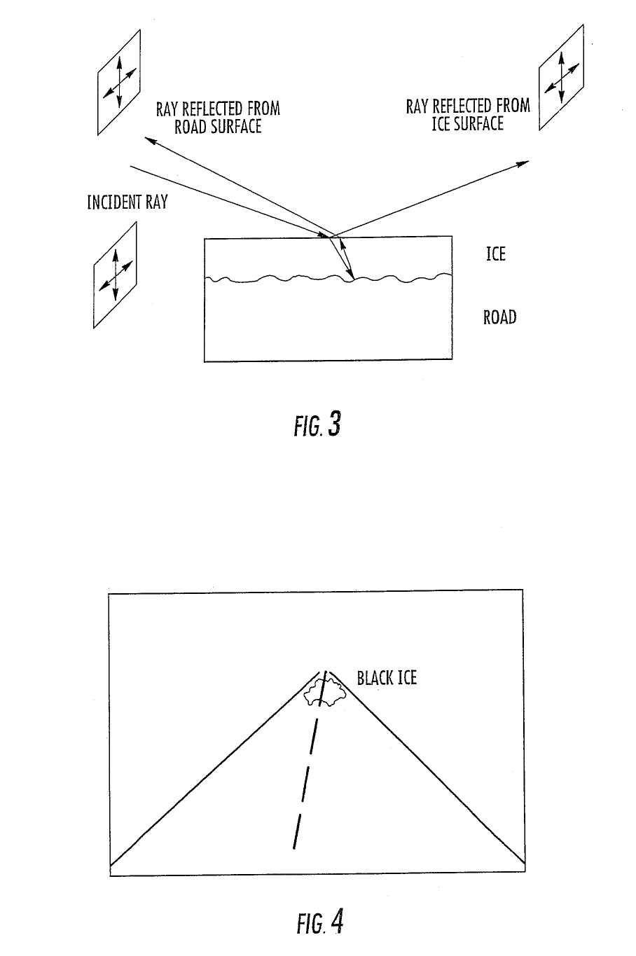

For example, and as shown in FIG. 2, if the light source and the light detector are at the opposite directions (i.e., the light source is directed toward the detected surface and the light detector or imaging sensor or camera is directed in the opposite direction and facing generally toward the surface and/or light source), the detector will detect the reflected light from the ice surface and an image processor may process the captured images to determine the polarization change. There will be almost no backward reflection on the smooth ice surface. Thus, if the light detector or imaging sensor or camera faces the same direction as the light source (such as by being at or near the light source and facing generally toward the surface), the detector may hardly detect any light signal that is reflected backward from the ice surface. However, if an ice layer is coated on a road surface that is rough (such that the road surface reflects/scatters light in substantially all directions, for diffuse reflection), there will be a backward reflection at the interface between the ice and the road surface. Because the driver does see the road surface under the illumination of the vehicle headlamps, this is evidence of back reflection of the headlamp light, and thus of a rough surface providing diffuse reflection. The detector that faces substantially the same direction as the light source thus may detect the backward reflected light. This backward reflected light carries the polarization changes that are caused by the ice surface. Such backward reflected light is depicted in FIG. 3.

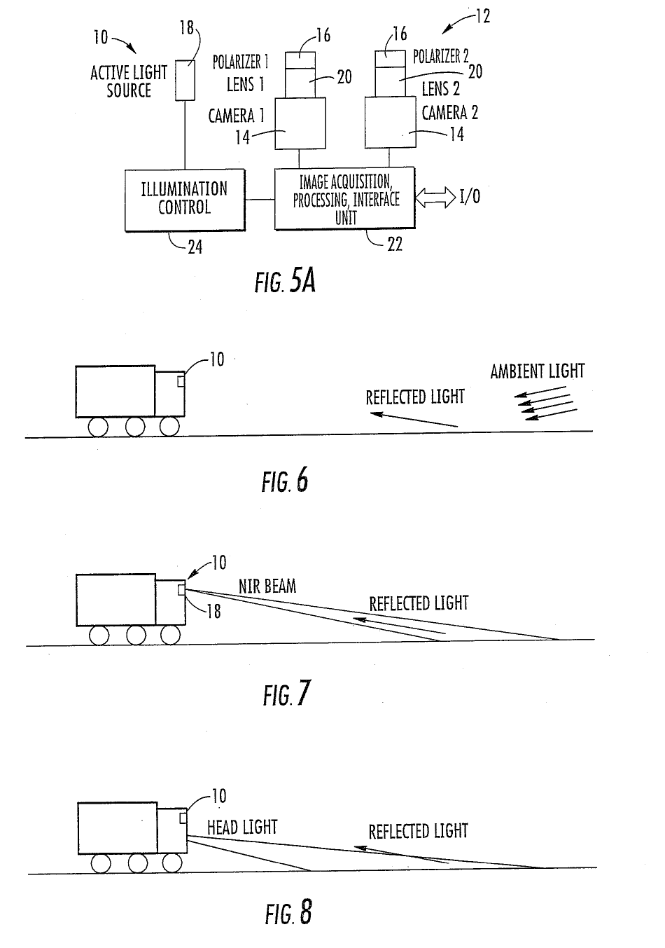

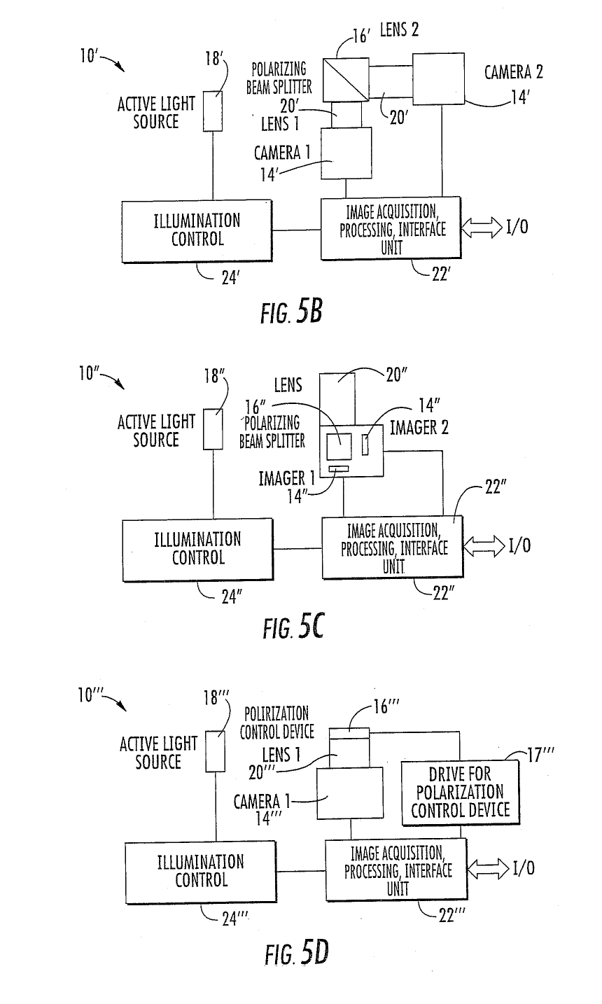

The black ice detection system 10 of the present invention includes an imaging sensor or camera system 12 (FIG. 5A), such as a special equipped camera system, that is at or in a vehicle and that has a forward field of view in the direction of travel of the vehicle (i.e., the camera looks ahead on the road at a certain distance and/or angle), such as through the windshield of the vehicle. The system includes one or two cameras 14, which are capable of taking images of the same scene but receiving light with two orthogonal polarizations (such as via one or more polarizers or polarizing filters 16 or the like). The polarizations may polarize the light so that light that is oriented generally parallel to the ground is passed through one polarizer and light that is generally perpendicular to the ground is passed through the other polarizer), or one −45 degree polarizer and one +45 degree polarizer (with the angles being measured or set relative to the ground or a horizontal plane) may be used, or one clockwise circular polarizer and one counterclockwise polarizer may be used, or one elliptical polarizer with long axis generally parallel to the ground and another elliptical polarizer with long axis generally perpendicular to the ground, or other angles or polarization configurations may be utilized as desired, without affecting the scope of the present invention.

As shown in FIG. 5A, the black ice detection and warning system 10 of the present invention includes camera system 12 that includes one or more cameras or imaging sensors 14 and the polarization selection device 16. In the illustrated embodiment, black ice detection and warning system 10 includes an illumination or light source 18 (such as a visible or near infrared light source), a spectral filter and one or more lenses or lens or optic elements 20 (one for each of the one or more cameras or imaging sensors). The cameras or imaging sensors may comprise any suitable imaging sensor or device, such as one or more CMOS or CCD cameras or the like. The black ice detection and warning system 10 includes a micro processor or image processor 22, and may include a digital signal processor and peripheral circuitry and/or electronics, such as an illumination source control 24 and/or the like.

Optionally, for example, a black ice detection system 10′ (FIG. 5B) of the present invention may include a polarization beam splitter 16′. The splitter may be a polarizing cube beam splitter, or a polarizing plate beam splitter or the like. In the illustrated embodiment, two cameras 14′ and respective lenses 20′ are mounted perpendicularly to receive two orthogonal polarizing beams from the splitter 16′. The black ice detection and warning system 10′ includes an active light source 18′ and a micro processor or image processor 22′, and may include a digital signal processor and peripheral circuitry and/or electronics, such as an illumination source control 24′ and/or the like. Black ice detection system 10′ may otherwise be substantially similar to black ice detection system 10, discussed herein, such that a detailed discussion of the black ice detection systems need not be repeated herein.

Optionally, for example, a black ice detection system 10″ (FIG. 5C) of the present invention may include one lens 20″ and a polarization beam splitter 16″ placed behind the lens. The two imagers 14″ are placed facing perpendicular to each other to receive two orthogonal polarizing beams from the splitter 16″. The black ice detection and warning system 10″ includes an active light source 18″ and a micro processor or image processor 22″, and may include a digital signal processor and peripheral circuitry and/or electronics, such as an illumination source control 24″ and/or the like. Black ice detection system 10″ may otherwise be substantially similar to black ice detection system 10, discussed herein, such that a detailed discussion of the black ice detection systems need not be repeated herein.

Optionally, for example, the black ice detection system of the present invention may include one camera/imager with a polarizer and another camera/imager without a polarizer. By processing the captured images and analyzing the image contrast between the captured polarized images and the captured non-polarized images, the system identifies black ice areas on the road.

Optionally, the black ice detection system 10″′ (FIG. 5D) of the present invention may include a lens 20″′ and a polarization control device 16″′ that is placed in front or behind the lens. The system also includes a drive circuit 17″′ that provides driving signal to control the polarization direction of the polarization control device 16″′. The polarization control device 16″′ acts as a polarizer and changes polarization direction according to the control signal from the drive circuit. The device's polarization state can be continuously switched between two orthogonal states in synchronization with the imager exposure frames. Optionally, the device's polarization state can be continuously switched between one or two polarization state/states and a non-polarization state in synchronization with the imager exposure frames. The black ice detection and warning system 10″′ includes an active light source 18″′ and a micro processor or image processor 22″′, and may include a digital signal processor and peripheral circuitry and/or electronics, such as an illumination source control 24″′ and/or the like. Black ice detection system 10″′ may otherwise be substantially similar to black ice detection system 10, discussed herein, such that a detailed discussion of the black ice detection systems need not be repeated herein.

By receiving and comparing the images of light at two generally orthogonal polarizations, an area with the presence of an ice layer on the surface of the road, which is usually transparent or invisible to human eyes and regular cameras, should be distinguishable via processing of polarization images. This is because the light reflected from the ice into the camera with the orthogonal polarized components will have different intensities relative to one another. Further, each of the polarization components will have a different intensity as reflected off the ice as compared to non-polarized light. The reflected light's different intensity provides contrast or pixel value differences in the captured image. In addition, in the images, the pixel value will change from a value for an icy area to a different value for the surrounding non-icy area, thus providing image contrast in gray level or color in the captured image. Comparing the pixel values in images with different polarization states or/and comparing polarized images to non-polarized images of a same scene allow the camera system to identify the black ice area that otherwise cannot be seen or detected with a non-polarized image. The methods of image comparison may include subtraction of images with different polarization states or the non-polarization state. The areas that show larger pixel value differences may indicate the existence of ice. In addition to comparing the pixel values, the system may also or otherwise use the color or texture changes in the road ahead to assist the ice identification. The polarization signature of the ice layer thus provides a means for detecting the presence of a black ice area on road surface in front of a vehicle. Such a polarization signature of reflected light is depicted in FIG. 4.

The black ice detection and warning system of the present invention is preferably operable to differentiate ice from water and snow because the water and snow are less slick than black ice (and thus the system may avoid providing warnings to the driver when the conditions in front of the vehicle may not warrant such a warning or alert). The real part of the indices of refractions of ice and water are 1.31 and 1.33, respectively, and thus the polarization difference between ice and water is relatively small. Thus, it may be difficult to differentiate water from ice by polarization alone. It is known that the imaginary part of the index of refraction, or absorption coefficient, differs significantly in some wavelength regions. By applying a spectral filter, which allows the camera to image at these spectral regions, the system can differentiate ice from water. On the other hand, snow, which is mainly comprised of ice grains and air, and a small amount of water when the temperature is close to 0 degrees C., can be differentiated or distinguished from ice also by the different absorption coefficients. The spectral filter may have multiple passing bands that allows light wavelengths of interest to be imaged by the imager and assist in differentiating ice from water or snow. Thus, the black ice detection and warning system of the present invention may utilize and apply a spectroscopic technique for this purpose, as discussed below.

In the near-infrared (NIR) wavelength region of the electromagnetic spectrum, water and ice have different spectrum responses, mainly in absorption because of the molecular structural differences between water and ice. By acquiring and analyzing images taken at one or multiple NIR wavelengths, the system can identify and distinguish between ice and water on the road surface. In the NIR region, the ice grain size also affects the absorption coefficient more significantly than visible region. By acquiring and analyzing images taken at one NIR wavelength or multiple NIR wavelengths, the system can identify and distinguish between ice and snow on the road surface.

Optionally, the black ice detection and warning system may also be operable to measure the thickness of the detected ice and water layers.

Optionally, other external means can also be used to help distinguish ice from water. For example, an outside or external temperature sensor of the vehicle can assist the system to tell that a detected patch in front of the vehicle is water and not ice if the ambient temperature is way above the freezing point. On the other hand, if the ambient temperature is substantially lower than the freezing point of water, the system may confidently identify the detected patch as ice with reduced confusion as to whether or not the patch may be water. The black ice detection and warning system thus may be responsive to an output of an external temperature sensor of the vehicle to determine whether a detected patch or formation constitutes water or ice.

Optionally, radio frequency electromagnetic waves may be used to identify ice and differentiate ice and water. Both the real and imaginary refractive indices of ice under radio frequency is many times greater than the ones of visible light. This characteristics allows the signal to have greater difference between two orthogonal polarizations, and thus increases the ice detection sensitivity. Forward facing Radar, such as the types used in ranging or adaptive cruise control or the like, may be used as or incorporated in the black ice detection system.

In order to detect and distinguish snow, the black ice detection and warning system may process the captured images to detect the intensity or brightness of the detected patch on the road surface in front of the vehicle. This is because snow is composed of small ice particles displaying different reflection behavior than water and ice, and appears brighter/whiter than a pure ice layer. This characteristic can help the system to distinguish snow from black ice. Further, processing and analyzing images of light having different wavelengths can also help to identify and distinguish between ice and snow on the road surface.

Optionally, a silicon based color sensor (such as a CMOS or CCD sensor or device) can be used to provide multi-spectral imaging as described above. A typical color sensor has photo sensing units, or pixels coated with red (R), green (G) and blue (B) filters. By combining the R, G and B pixels in a repetitive pattern (a typical pattern being commonly referred to as a Bayer pattern), the sensor provide color images. Common R, G or B filters all have a strong NIR “tail”, in other words, they allow significant NIR light pass through the pixel color filters to be detected by the silicon photo cells. Using different color filters, by some simple on-imager or post-imager arithmetic calculation, one can receive images at R, G, B and multiple NIR regions at the same time (such as by utilizing aspects of the imaging system described in U.S. provisional application Ser. No. 60/977,430, filed Oct. 4, 2007, which is hereby incorporated herein by reference in its entirety). This would allow for utilization of a low cost silicon imager, such as a CMOS imager or the like, to be used in the black ice detection system.

Optionally, the black ice detection and warning system of the present invention may also communicate with vehicle communication buses to receive vehicle information, such as status information of various vehicle systems or accessories or the like. For example, the system may receive information including, but not limited to the current vehicle speed, the steering angle, an antilock brake system (ABS) status, an electronic stability control system status, an external temperature and/or the like. The black ice detection and warning system of the present invention may also send or communicate or output information that may be received by other systems of the vehicle. Such outputs may include, for example, a warning of the detection of ice on the road surface, a distance to the detected ice, an estimated time to reach the detected ice, the type of ice/snow/water that is detected (ice, dry snow, wet snow, slush snow, water). The distance of the ice detected will ordinarily be determined or calculated based on a trigonometric and optical conversion of the location of the ice in the detector's image space to the physical space around the vehicle, assuming typical vehicle orientation. A sensor, such as accelerometer or other type of sensor, in an electronic stability control system may enable vehicle pitch to be calculated, and this pitch information can enable the black ice system to use trigonometry to bias the ice detection distance.

The black ice detection and warning system may also directly present or indicate the ice warning to the driver of the vehicle, such as via a light or lights, an icon on the dashboard or instrumentation panel, or an indicator or icon at or on or near a rearview mirror (such as at or on or near an interior rearview mirror of the vehicle or at an accessory module or windshield electronics module of the vehicle), an audible signal or sound, a vibration or other tactile or haptic signal (such as a vibration of the steering wheel or the like), a voice signal, and/or the like. Optionally, the black ice detection and warning system may control one or more of the vehicle systems, such as the vehicle accelerator or braking system of the like, so as to assist the driver in avoiding the detected hazardous condition.

Optionally, and desirably, the black ice detection and warning system can be mounted inside a vehicle, such as at the back of an interior rear view mirror assembly of the vehicle or other suitable places, such as at or in a windshield electronics module or accessory module at or near the interior rearview mirror assembly of the vehicle and at or near the windshield of the vehicle. In such locations, the imaging sensor or camera preferably has a forward field of view through the windshield of the vehicle and preferably through an area cleaned or wiped by a windshield wiper of the vehicle when the windshield wiper is activated. The forward facing camera and system may be positioned at or near or beside other forward facing sensor systems, or may be integrated with one or more other camera-based forward facing imaging or vision systems, such as systems for rain sensing, headlamp control, lane departure, crash/collision warning, adaptive cruise control or the like. Optionally, the forward facing camera and/or blind spot detection system may be mounted elsewhere at the vehicle, such as at or near or inside a forward facing lamp of the vehicle, such as a headlamp or fog lamp of the vehicle, while remaining within the spirit and scope of the present invention.

The black ice detection and warning system of the present invention is operable to detect black ice in both day light and night light conditions. Under day light condition, the system can be operated in either a passive mode or an active mode (which includes activation of the illumination source 18 (FIG. 5) for illuminating the detected region in front of the vehicle).

In the passive mode (such as shown in FIG. 6), the reflection of ambient light is captured by the imaging sensor or sensors and is processed and analyzed for polarization changes to detect black ice of road surface. Thus, when the system is operating in the passive mode, the ambient light or normal daylight is used as the light source for imaging. The normal daylight is slightly polarized due to scattering of sun light from particles in the air. This polarization acts as a small and constant background signal across the image, which can be offset and canceled during image processing. The polarization changes from the ice regions, however, appear localized on the road only and can form localized contrast areas in the image, such that the system can identify icy areas on the road in front of the vehicle. The advantages of the passive mode may include, among others:
not relying on an additional light source (such as a light emitting diode (LED) or laser diode or the like) which may subject to regulation; and
receiving directly reflected light from the road or ice surface, thus potentially increase the polarization image contrast.

The disadvantages of the passive mode may include:
the system may be subject to ambient light condition changes; and/or
the system may have a low sensitivity or may have difficulty in detecting ice at night or low lighting conditions.

In the active mode (such as shown in FIG. 7), a light or illumination source, such as a near infrared (NIR) light source, such as a laser diode or a light emitting diode (LED) or the like, and preferably with a focusing lens or element, can be used to illuminate the road at the desired or appropriate distance in front of the vehicle. In the active mode (such as with a NIR light source activated), the reflected light is captured by the imaging sensor or sensors and processed and analyzed for polarization changes to detect black ice on the road surface. The selection and use of a near infrared light source (emitting light with wavelengths in the near infrared region of the electromagnetic spectrum) may provide, for example, the following benefits:
the near infrared light or illumination is substantially not visible to human eyes, so the use of such light sources will not be glaring to the drivers in oncoming traffic;
silicon based imaging sensors or cameras are typically more responsive to near infrared light, particularly having wavelengths between 700 nm and 900 nm, such that such light sources provide better responsivity to silicon based imagers, and thus provide a better signal to noise ratio for the camera system; and
a lower imager and light source cost than mid-IR or far-IR light sources (known mass produced automotive grade CMOS imagers (such as Micron 354, 350 or 360) may be used, as well as low cost near-IR LED and laser diodes and the like).

During night time or low day light conditions, the active mode described above should be used. Optionally, the illumination source may be activated in response to an ambient light sensor, such that the system operates in the active mode when the ambient light levels are detected to be at or below a threshold level. With a near-IR illumination from laser diodes or LEDs or the like (such as shown in FIG. 7), the imager can work without interference from the light from vehicle headlamps. Advantages of the use of such a laser diode or LED illumination may, for example, include:
the camera is not subjected to the effects from ambient light changes, such that a simpler software algorithm is needed as compared to the passive mode; and
controllable and consistent illumination results in better system performance.

Disadvantages of the use of such a laser diode or LED illumination may include:
such additional forward pointing active light sources may be subject to regulation; and/or
light received by the camera is not directly reflected from the ice surface, it is reflected from the road surface which is beneath the ice layer, which may result in a reduced detection sensitivity as compared to the passive mode.

It is also feasible to use the near-IR spectrum of the headlamp beam light as the illumination source (such as shown in FIG. 8). Such a system may eliminate the regulation restriction of the laser or LED illumination sources. However, the low beam headlamp beam may not illuminate a sufficient distance in front of the vehicle to provide enough warning time to the driver of the vehicle. Thus, the high beam headlamp setting should be used in this regard. Because the high beam should be turned off (i.e., the low beam setting should be used) if an oncoming vehicle or leading vehicle is present on the road in front of the subject vehicle, the driver cannot always rely on the high beam as an illumination source for black ice detection. Optionally, however, the system may utilize a pulse width modulation (PWM) of the high beam output, in which case very short pulses of the high beam can be used without posing glaring effect to other driver's eyes. Further, the short pulses are preferably synchronized with the exposure frames of the camera of the black ice detection and warning system so as to provide sufficient and reliable illumination for the black ice detection and warning system. Optionally, one or more near-IR LEDs may be mounted inside or at or near the low beam or high beam headlamps of the vehicle or inside or at or near the fog lamps of the vehicle. The LEDs may be powered and controlled separately from the head lamps and/or fog lamps, so that the black ice detection and warning system is not affected by the status of low and high beam lamps and fog lamps.

Optionally, the black ice detection and warning system may utilize one or more capabilities of some commercial available imagers, such as control imager register settings for individual frames. For example, the Micron CMOS imager 350 has a global shutter and its registers can be instantly and independently controlled for every frame. The registers include, but are not limited to; the exposure time, gains (global and individual colors), binning, region of interest, high dynamic mode, companding and the like. Further, one can control the illumination source or sources in the form of variable pulse periods, duty cycles, intensities and polarizations. The changes in illumination provided by the illumination source can be synchronized with the imager frames. For example, the imager can change its exposure time and gain in synchronization with a controlled variation of the pulse period, duty cycle, and/or intensity of the illumination source. In doing so, the system can enhance the sensitivity of ice detection by selecting optimized lighting and frame settings for different environmental and road conditions.

In addition, the black ice detection and warning system may use a controllable polarizer in front of the camera to switch two polarization states alternatively in sequence. By doing so, the system can eliminate one set of a camera and lens to reduce the system cost and save packaging size. One example of such controllable polarizer is a liquid crystal based polarization rotation device, such as the ones used in LCD monitors and projectors. A potential drawback of such an approach is that consecutive frames may have minor differences in images (for example, 1.3 meters difference between two consecutive frames for a 15 frames per second imager). However, the image difference is more noticeable in the near field, such that for an object at as far as 50 meters or more, the image difference may be too small to notice or discern. Also, it is possible to compensate such frame to frame differences via image processing of the captured images.

With the capabilities of changing region of interest (ROI) and binning in imager for every frames, the system can use one frame with low resolution (with binning) and/or full frame or large ROI to identify a suspected ice area, then a second or subsequent frame with higher resolution (without binning) and/or smaller ROI, which may be focused at or near or around the suspected area to increase the detection confidence of the system.

Similarly, after the system identifies a possible ice area using a frame with the general exposure setting, the next frame or frames may be switched to an exposure setting that may increase the ice detection sensitivity, in order to increase the detection confidence of the system. For example, a selected exposure setting may increase the brightness and contrast of a relatively dark road to enhance the ice contrast while saturating other portions of the scene that are not as relevant or important.

Furthermore, to increase the reliability of separating or distinguishing between ice and snow and water, the black ice detection and warning system may utilize several exposure settings for different wavelength detections. This can be done by setting the exposure and gain for individual Bayer colors in each of the captured frames. Selecting and controlling the frame in the imager may allow the system to capture images at different spectrum ranges.

Optionally, the black ice detection and warning system may also be integrated with and share system resources with other forward facing systems, like Lane Departure Warning or headlamp high beam control by controlling illumination and dividing frames.

The black ice detection and warning system may broadcast the black ice information and warning signal to other receivers or receiving parties. The receiving parties may include, but are not limited to, other vehicles on the road close by the subject vehicle, one or more receiving stations nearby the subject vehicle, a central server or the like. The broadcasting means may include, but are not limited to, Wi-Fi, BLUETOOTH®, other short range radio communication protocols or other wireless or radio communication protocols, IR or NIR light, or visible light. The broadcast information may include the GPS data of the black ice area detected, such as, for example, the latitudinal and longitudinal coordinates of the detected ice area, the time of the detection, the speed of the vehicle, information indicative of whether an accident has occurred, and/or the like. The vehicles following the broadcasting vehicle thus may receive the warning and take action to slow down, brake, avoid the lane or change their respective route. Upon receiving the black ice hazardous warning information from a broadcasting vehicle, the receiving station or router station can process the warning information and re-broadcast the warning information to a farther distance and range, or route the warning information to the central station for providing a warning to other vehicles, such as via radio frequency communications or satellite network communications, so that the warning may be received and heard over another vehicle's radio or audio system or viewed or heard at another vehicle via an internet connection or satellite communication.

Optionally, the black ice detection and warning system can send the black ice information directly to the vehicle control system modules, such as anti-lock brake system, traction control system, stability control systems, airbag and seatbelt safety control systems and cruise control systems. The detection of the black ice thus may allow the vehicle to automatically take actions without driver intervention. The black ice detection and warning system sends black ice information through vehicle communication bus (such as, for example, CAN, LIN or J1850 or the like). The responsible control systems of the vehicle thus may take actions, such as pre-energize or pre-engage the braking system or the anti-lock braking system, disengage the throttle, pre-tighten the seatbelt and/or pre-energize the airbag deployment control systems, and/or the like, in response to the information indicative of a detected icy area.

Optionally, the black ice detection and warning system can be pointed to a closer distance to provide better black ice detection sensitivity. When the light incident angle is increased at the shorter detection distance, the signal difference between the two orthogonal polarizations increases, and thus the pixel value contrast between the corresponding polarization images increases. Such a configuration thus increases the black ice detection sensitivity. While it requires a farther detection distance in advance of the vehicle to provide a longer response time for the driver to react to the warning or alert, the direct sending of or communication of black ice detection information to one or more vehicle control modules requires less advance warning time, so that the system may have the camera directed to an area that is at a shorter distance in front of the vehicle than the area at which the camera may be directed for providing a driver warning or alert signal.

The black ice detection and warning system of the present invention thus may detect black ice in front of a vehicle and provide a warning or indication to the driver of the host vehicle that black ice or snow or ice or water has been detected in front of the host vehicle. The black ice detection and warning system may include any imaging sensor or sensors, and may utilize aspects of various vision or imaging or detection systems, such as, for example, blind spot detection systems described in U.S. Pat. Nos. 7,038,577; 6,882,287; 6,198,409; 5,929,786; and/or 5,786,772, and/or U.S. patent application Ser. No. 11/239,980, filed Sep. 30, 2005 by Camilleri et al. for VISION SYSTEM FOR VEHICLE (Attorney Docket DON01 P-1238); and/or Ser. No. 11/315,675, filed Dec. 22, 2005 by Higgins-Luthman for OBJECT DETECTION SYSTEM FOR VEHICLE (Attorney Docket DON01 P-1253), and/or U.S. provisional applications, Ser. No. 60/638,687, filed Dec. 23, 2004 by Higgins-Luthman for OBJECT DETECTION SYSTEM FOR VEHICLE; Ser. No. 60/628,709, filed Nov. 17, 2004 by Camilleri et al. for IMAGING AND DISPLAY SYSTEM FOR VEHICLE; Ser. No. 60/614,644, filed Sep. 30, 2004; and/or Ser. No. 60/618,686, filed Oct. 14, 2004 by Laubinger for VEHICLE IMAGING SYSTEM, and/or reverse or backup aid systems, such as rearwardly directed vehicle vision systems of the types described in U.S. Pat. Nos. 7,005,974; 5,550,677; 5,760,962; 5,670,935; 6,201,642; 6,396,397; 6,498,620; 6,717,610 and/or 6,757,109, and/or of automatic headlamp control systems of the types described in U.S. Pat. Nos. 5,796,094 and/or 5,715,093; and/or U.S. patent application Ser. No. 11/105,757, filed Apr. 14, 2005 by Schofield et al. for IMAGING SYSTEM FOR VEHICLE (Attorney Docket DON01 P-1208); and/or U.S. provisional application Ser. No. 60/607,963, filed Sep. 8, 2004 by Schofield for IMAGING SYSTEM FOR VEHICLE, and/or rain sensors or rain sensing systems of the types described in U.S. Pat. Nos. 6,250,148 and 6,341,523, and/or of other imaging or detecting systems, such as the types described in U.S. Pat. Nos. 6,353,392 and 6,313,454, which may utilize various imaging sensors or imaging array sensors or cameras or the like, such as a CMOS imaging array sensor, a CCD sensor or other sensors or the like, such as the types disclosed in commonly assigned, U.S. Pat. Nos. 5,550,677; 5,760,962; 6,097,023 and 5,796,094, and U.S. patent application Ser. No. 09/441,341, filed Nov. 16, 1999 by Schofield et al. for VEHICLE HEADLIGHT CONTROL USING IMAGING SENSOR (Attorney Docket DON01 P-770), and/or PCT Application No. PCT/US2003/036177 filed Nov. 14, 2003, published Jun. 3, 2004 as PCT Publication No. WO 2004/047421 A3, with all of the above referenced U.S. patents, patent applications and provisional applications and PCT applications being commonly assigned and being hereby incorporated herein by reference in their entireties.

The black ice detection and warning system of the present invention thus may detect and warn of black ice on a road surface in front of a vehicle. The system may be implemented on passenger vehicles or other vehicles, such as commercial vehicles, specialty vehicles at airports, postal delivery vehicles, and other types of vehicles and/or applications that are subject to black ice hazard. It is further envisioned that the black ice detection and warning system of the present invention may be applied to checking or detecting an ice condition on airplane wings and bodies and on airport runways or the like. The black ice detection and warning system may also be used as stationary ice monitoring systems for roadways, parking lots, entrances, and other places where the presence of surface ice creates a potentially hazardous driving and walking condition.

Changes and modifications to the specifically described embodiments may be carried out without departing from the principles of the present invention, which is intended to be limited only by the scope of the appended claims as interpreted according to the principles of patent law.

1. A black ice detection system for a vehicle, said black ice detection system comprising:
an imaging sensor disposed at the vehicle and having a forward field of view in a direction of forward travel of the vehicle; and
a control operable to process images captured by said imaging sensor and operable to detect and discern black ice on a surface in front of the vehicle in response to said image processing.

2. The black ice detection system of claim 1 further comprising a polarizing element that polarizes light such that light waves in one or more particular orientations are received by said imaging sensor and light waves in other orientations are substantially attenuated.

3. The black ice detection system of claim 1 further comprising an illumination source that is selectively actuatable to illuminate an area in front of the vehicle.

4. The black ice detection system of claim 1, wherein said black ice detection system provides an alert or warning signal to the driver of the vehicle to alert the driver that black ice has been detected ahead of the vehicle.

5. The black ice detection system of claim 1, wherein said black ice detection system is operable to detect and discern other ice and snow and water formations or patches that are detected on the road surface ahead of the vehicle or otherwise in the path of the vehicle.

6. The black ice detection system of claim 1, wherein said imaging sensor is disposed at an interior rearview mirror assembly of the vehicle and has a forward field of view through the windshield of the vehicle.
